(19) United States
(12) Patent Application Publication
(10) Pub. No.: US 2009/0216727 A1
(43) Pub. Date: Aug. 27, 2009

(54) Viewer User Interface

(76) Inventors: David Dozoretz, Los Angeles, CA (US); Michael A. Catalano, Los Gatos, CA (US); Mitchell Louis Berman, Menlo Park, CA (US); Benjamin Silva, III, Fremont, CA (US); Bradley S. Hochberg, San Jose, CA (US); Hunter Kuhnert, Santa Monica, CA (US); Simon Jasen Halpern, West Hollywood, CA (US)

Correspondence Address: CARR & FERRELL LLP, 2200 GENG ROAD, PALO ALTO, CA, 94303, US

(21) Appl. No.: 12/390,234

(22) Filed: Feb. 20, 2009

Related U.S. Application Data
(60) Provisional application No. 61/066,659, filed on Feb. 21, 2008.

(51) Int. Cl. G06F 17/30

(52) U.S. Cl. 707/3; 707/E17.014

(57) ABSTRACT

Systems and methods for displaying media and associated information are disclosed. A hybrid user interface may include aspects of push and pull interfaces. In some embodiments, media may be characterized by parameters and values for the parameters. Parameters and values may be associated with a user's interests, and a user may identify media by searching for media using one or more preferred values of parameters of interest. In some cases, media are presented to a user. Presented media may share values for parameters associated with the user's interests. Certain embodiments deliver (e.g., play) items of media content.

### CROSS REFERENCE TO RELATED APPLICATIONS

This application claims the priority benefit of U.S. provisional patent application No. 61/066,659, filed Feb. 21, 2008, the disclosure of which is incorporated herein by reference. The present application is related to U.S. patent application Ser. No. 12/316,033, filed Dec. 8, 2008, the disclosure of which is incorporated herein by reference.

### BACKGROUND

1. Field of Invention

The present invention relates generally to media content and user interfaces.

2. Description of Related Art

A large variety and number of media (or items of content) are available for consumption by a user (i.e., a viewer, a listener, or other consumer). Exemplary media items include movies, songs, television shows, pictures, sporting events, web pages, blogs, podcasts, and the like. Media may include presentations, items created by friends or colleagues, products, indicia of products or services, and links to customized environments. Media may include a variety of experiences associated with social networks. The provision of media to a user has often been via one of two different interfaces (and by extension, business models). A “push” interface (such as a radio station or television channel) typically provides a predetermined series of items (e.g., songs or TV shows) on a given channel. A “pull” interface (such as Video on Demand, VOD), typically allows a user to choose an already-identified item of content.

A “push” interface does not typically provide a user with control over the specific content received. Rather, a user chooses a channel and accepts whatever content is provided on the channel. In some cases, the user receives desired content; in other cases, undesirable content is pushed to the user (often resulting in the user changing channels).

Content is typically provided by a content provider, such as an artist, an author, a production house, or another entity that creates content. In a push interface, the choice and control of content pushed to a user is typically via an intermediary (e.g., a TV network or radio station). The intermediary acquires (purchases, leases, or otherwise provides) content from the content provider, and often negotiates with advertisers based on provided content. Acquired content is typically pushed to the user via channels controlled by the intermediary. Associated advertising is often pushed with the content, and advertising is chosen to match the content, rather than matched to an individual user.

Push interfaces may push undesirable content. As such, a consumer may need many channels available in parallel, such that s/he may change from a channel having undesirable content to one having desirable content. In some cases, a user desiring a certain type of content may require access to (or even be forced to purchase) a plurality of channels in order to have access to a single desired channel or a single type of content. For example, a user may be forced to purchase a “bundle” of channels in order to access desired content on a single channel. In some cases, a user may be required to purchase a channel in order to access an item of content (e.g., purchase a Sports channel to access a certain college football game or games).

In some cases, the number of available channels may be very large (greater than 57 channels, 570 channels, or even 5700 channels), with each channel having some probability of having desired content. A user typically scrolls through channels, viewing available programs at the present time (or in the future), and chooses upon identifying a desired item.

“Pull” interfaces may offer a user the opportunity to choose specific items of content. A desired song may be downloaded from the internet. A desired movie may be ordered for viewing. An LP record may be purchased. Such interfaces typically require the a priori knowledge of which item of content is desired. For example, a user may wish to choose from among thousands of movies, hundreds of thousands of songs, millions of web pages, or other large numbers of media items.

As the diversity and number of available media increases, a user's choice of an item may be made from a larger and larger set of options. For very large sets, finding and choosing a desired item of content may be tiresome. In some cases, media enjoyment may be reduced because finding a desired item in a large set of options is tedious. In other cases, a user may be unaware that desirable (yet unknown) content exists for consumption, and so has no reason to choose the content for consumption. Moreover, a pull interface is typically designed to facilitate a user's finding of a desired item of content after having already identified it (i.e., the user already “knows” what s/he wants to watch, and seeks to “order” or “demand” the item).

Typical interfaces present a user with a graphical display whose dimensions are static and well known (e.g., channel vs. time). However, some users may wish to choose media based on characteristics other than those such as channel, time, or title.

### SUMMARY OF THE INVENTION

Various embodiments include a digital media component comprising first hardware and software configured to instruct a display device to display a representation of one or more parameters characterizing one or more media, a range of values (or a value) for at least one of the represented parameters, and indicia of one or more media having values for at least one of the represented parameters within the range. The digital media component may include second hardware and software, connected to the first hardware, and configured to send a query request to a database of media and associated parameters, receive a query result respondent to the query request, and communicate the query result to the first hardware.

Some embodiments are configured to receive an input identifying any of a parameter, a value, a range of values, one or more indicia, and an item of media content. An input may be received from a remote control. An input may be used to generate a query request reflecting the input.

Indicia, media, and/or other graphical representations of information may be arranged in one or more directions. In some embodiments, a direction is associated with indicia sharing values for one or more parameters associated with the direction. A direction may be linked to a query result. An order (e.g., of indicia) in a direction may be associated with values of one or more parameters characterizing the indicia.

Parameters describing media may be used to identify and/or choose an item for viewing or listening. In some cases, first media are proposed, and a user's response to the first media (e.g., a user's enumeration of parameters of interest) is used to find second media sharing values for parameters of interest to the user.

In some embodiments, a method includes receiving first information associated with an interest of a first user, identifying one or more parameters within the first information (each parameter typically including one or more values associated with the interest), querying a database (e.g., a relational database) for one or more items of content having the value of the identified parameter, receiving a query result including indicia of items of content satisfying the query, and proposing one or more of the returned indicia to a second user. In some cases, the second user is the first user.

In certain embodiments, a user creates or modifies a preference setting characterizing interests of the user. In some cases, a profile of a user may be created, which may include a history of the user's choices of parameters, values, and/or media.

A method may include identifying or creating a preference setting, displaying information including a representation of one or more metadata (e.g., a parameter and a range of values for the represented parameter), receiving input that identifies one or more values within the range, and updating the preference setting to reflect the received input.

In some cases, the received input may be used to generate a query request reflecting the input. The query request may be used to query a database of media information, and a corresponding query result may be used to update the representation. An updated representation may reflect the latest or most recent query request, and may represent media satisfying the query result.

A method may include receiving a first input identifying a parameter and one or more values for the parameter. A database may be queried for media having a matching value for at least one of the identified values. Indicia associated with media satisfying the query may be displayed, and input choosing at least one of the displayed indicia may be received. Media corresponding to the chosen indicia may be played.

Some embodiments include a media information system comprising a processor connected to a computer readable storage medium having embodied thereon a program executable by the processor to perform one or more methods. A method may include instructing a display device to display information comprising a representation of one or more parameters characterizing one or more media, a range of values for at least one of the represented parameters, and first indicia of one or more media having a value for at least one of the represented parameters within the range. The method may include receiving an input identifying any of a parameter, a value, a range, one or more indicia, and one or more items of media. A query request reflecting the input may be generated and sent to a database of media and associated metadata. A query result satisfying query request may be received, and second indicia associated with media satisfying the query result may be displayed.

In some embodiments, a user identifies a range of values associated with a plurality of parameters characterizing a plurality of media. The parameters, values and ranges may be used to create a profile associated with the user, and media sharing values with the user's profile may be proposed to the user.

In certain cases, a profile associated with a plurality of first users may be used to identify media (e.g., media sharing values with the profile) for a second user. In certain cases, the second user may be included in the plurality of first users (e.g., a social or other network of first users).

### BRIEF DESCRIPTION OF THE DRAWINGS

FIG. 1 is a diagrammatic representation of a media system, according to certain embodiments.

FIG. 2 is a schematic illustration of a box, according to certain embodiments.

FIG. 3 illustrates a graphical representation of two exemplary items of content characterized by several exemplary parameters for illustrative purposes, according to some embodiments.

FIG. 4 illustrates a graphical arrangement of indicia associated with several items of content, according to certain embodiments.

FIG. 5 illustrates a display having two directions, according to some embodiments.

FIG. 6 illustrates a display according to certain embodiments.

FIG. 7 illustrates a display of a query request and an exemplary query result according to certain embodiments.

FIGS. 8A and 8B illustrate a control bar, which may be used as a filter in some embodiments.

FIG. 9 illustrates a results region according to some embodiments.

FIG. 10 illustrates a flow chart of an exemplary method for providing media information through an interface, according to certain embodiments.

FIG. 11 illustrates a flow chart of an exemplary method for updating a preference setting, according to certain embodiments.

FIG. 12 illustrates a flow chart of an exemplary method for providing media, according to certain embodiments.

### DETAILED DESCRIPTION OF THE INVENTION

Various aspects include a user interface for obtaining and viewing media. Some embodiments combine features of push and pull interfaces. In some cases, one or more playlists may be populated with media. A playlist may be a sequence of media available for consumption. In some cases, a user may find and choose media by choosing values for one or more parameters (or metadata) associated with the media. In some embodiments, a profile may be created for a user. A profile may be used to propose items of media that may be of interest to the user. In some cases, a user's prior identification of parameters of interest (e.g., in the context of identifying media of interest having certain values for those parameters) may be used to propose media sharing values for one or more of those parameters.

Media may be characterized by one or more parameters. In some embodiments, media may be characterized by more than 10, 100, 1000, or even 10,000 parameters. A parameter may characterize one or more media. A parameter may take one or more values, and a value may be attributable to one or more media. For example, a TITLE parameter may take a value having the title of a particular movie, TV show, song, sporting event, broadcast, or other media. In some cases, parameters and their associated values may be described as key-value pairs (KVPs), in which a key (or parameter) and its associated value describes one or more aspects of an item of content. In some embodiments, media are described by one or more associative arrays. Certain embodiments include a multi-map data structure.

A user's preference(s) for media may be based upon media having preferred values for one or more parameters. For example, a user that enjoys 1970's television shows may have a preference for media characterized by a RELEASE_DATE parameter having values between 1970 and 1979, and a TYPE parameter having a value “TV show.” A parameter may annotate media that a user has already watched, has already identified as “of interest” but unwatched, or otherwise identified as desirable.

A user's preference for media may be used to propose or offer other (e.g., heretofore unwatched) media. A previously unknown item of content sharing values with a preferred set of media may be presented to a user based on the item's correlation with the user's preferences or the preferred set. Thus, the aforementioned watcher of 1970's TV shows may be offered other types of media (e.g., movies, songs) having RELEASE_DATE values between 1970 and 1979. The user might also be offered 1970's TV shows that star an actor that also starred in one of the user's preferred TV shows. Proposing such media may include identifying one or more parameters associated with a user's interest, querying a database for media characterized by those parameters (e.g., meeting a constraint on values), and offering (or even playing) one or more media that meet the query constraints.

A user's preferences may be associated with a single parameter (e.g., STAR=“Humphrey Bogart”). A user's preferences may be associated with a combination of two or more parameters, and in some cases, with subsets of their respective values. For example, a user may enjoy movies from Metro-Goldwyn-Mayer (MGM), but only those movies released before 1945. In some cases, a user's preference may be associated with a subset of media having certain values for certain parameters. A user may have some preferences that are relatively “fixed” with time (e.g., a desire to avoid Motion Picture Association of America (MPAA) ratings of “X”) and others that change or evolve with time (such as preferring World News in the morning and Cartoons in the afternoon). A user's preference may be associated with values for more than five, ten, twenty, fifty, or even hundreds of parameters.

Parameters may describe a unique item of content (e.g., the men's 1998 World Cup Soccer final match) and/or many items (e.g., all matches from the 1998 World Cup). Parameters may characterize a range of qualities or aspects of media. For example, a parameter TOPIC having a value “shoes” may be associated with episodes of the TV show “Sex and the City” focused on shoes, the movie “The Wizard of Oz,” and the song “Blue Suede Shoes.” In some cases, a parameter and associated values are provided by a third party, such as an advertiser. For example, the Aston Martin automobile company may wish to create parameters associated with media (e.g., some James Bond movies) featuring Aston Martin automobiles.

In some cases, a user provides or creates a parameter and an associated value, “tagging” the media with the parameter. In some cases, a first user tags an item of content, and a second user identifies the tagged item using the first user's tag.

Media, parameters, and their associated values may be stored in a multidimensional database. In some cases, media and their metadata are stored in a relational database, such as an Oracle™ database. Certain embodiments include a database relational management system. In some embodiments, a database may be queried, for example using a structured query language (SQL). Certain embodiments include graphical interfaces that receive input and formulate the input into a query.

A user seeking content may choose one or more desired parameters, identify one or more ranges of values for these parameters, and receive content having parameter values within the identified ranges. In some embodiments, a desired set of parameters and/or values is formulated into a query. The query may be submitted to a database, and corresponding metadata and media meeting the query may be returned to the user.

In addition to receiving requesting content, media content can automatically be selected and proposed to a user. Actions performed by the user may be stored, such that a user profile is created. Such a profile may be used to propose additional media to the user. In some embodiments, a user may modify his/her profile. First and second users may have a common or associated profile (e.g., a network profile or demographic profile or zip-code profile).

A user's behavior (e.g., choosing parameters, choosing values for parameters, choosing media, skipping or viewing advertisements, and the like) may be stored. In some cases, a profile for a user is created using stored behavior. A profile may include media watched by the user parameters and/or values associated with media of interest (e.g., media viewed by the user). A profile may be associated with a hardware device. In some cases, a profile can be associated with an internet protocol address, a pattern of gestures of a user, and a digital image of a user (e.g., a user identified by a digital camera). In some embodiments, facial recognition software may be used to identify a user in a digital image which contains a picture of the user's face.

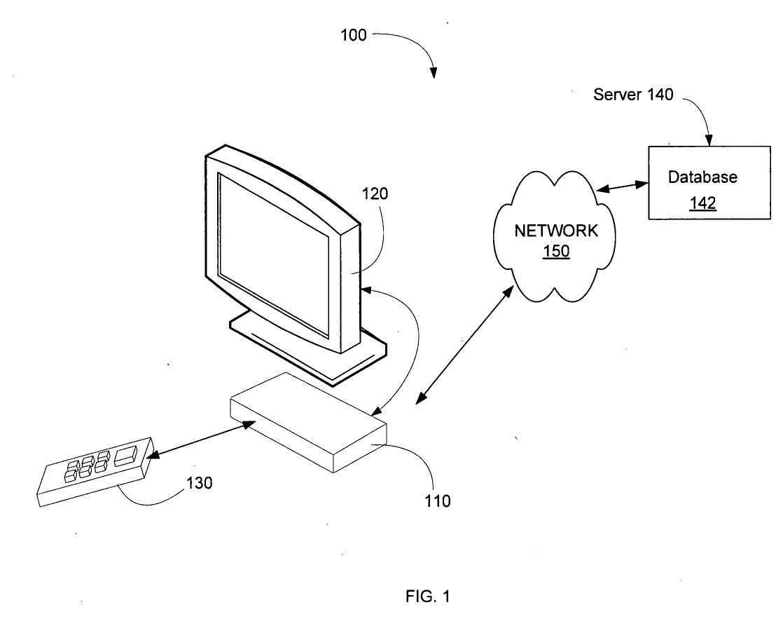

FIG. 1 is a diagrammatic representation of a media system, according to certain embodiments. In this example, media system 100 includes a set-top box 110 configured to control a display device 120. Display device 120 may include a video display and/or an audio output (e.g., a speaker or headphone jack). Display device 120 may include a flat panel display, a projection display, a cathode ray tube, a liquid crystal display, a plasma display, an OLED display, or another type of display device. Set-top box 110 and display device 120 are communicatively connected, and may communicate, for example, via electrical (e.g., S-video, HDMI), optical, and/or wireless (e.g., wireless HDMI, 802.*) connections. In certain embodiments, set-top box 110 may be integrated into display device 120.

Set-top box 110 may provide media and/or associated metadata to a user. A user may control set-top box 110 to choose and display media on display device 120. In some embodiments, set-top box 110 may be controlled using remote 130. Remote 130 communicates with set-top box 110 (e.g., by transmitting an RF signal, an infrared signal, an acoustic signal, or even a hardwired signal), often in response to receiving input from the user. Set-top box 110 may also transmit a signal to remote 130. In some embodiments, remote 130 is physically separated from set-top box 110, and may generally communicate wirelessly with set-top box 110 using one or more optical (e.g., infrared) and/or radio frequency (e.g., 802.*) communications protocols. In other embodiments, remote 130 is physically integrated with set-top box 110.

Set-top box 110 can be implemented as a digital media device that includes several components of hardware and/or software which perform the functionality described herein. For example, a first component of the set-top box can control a display device to display various types of information. A second component of the set top box can communicate with remote machines, for example database 142, web servers and application servers. The second component can send query requests and receive query results regarding user data and media data and communicate information regarding query requests and results with the first component.

Some embodiments of set-top box 110 include a sensor or other input device (e.g., a button, trackball, touch screen and the like). In some cases, an input device may be operated by a user to cause remote 130 to emit a signal whereby the remote control may be located. Appropriate signals include audible (e.g., an alarm), vibratory (e.g., “buzzing”), and/or visible (e.g., a blinking LED) signals.

Some embodiments of set-top box 110 provide for the receipt of physical memory devices (e.g., discs, memory cards, memory sticks and the like) and/or circuitry to connect to storage devices (e.g., a USB, USB2, optical, and/or Firewire port). In some applications, such devices may include media (e.g., movies, songs, TV shows) and/or media information (e.g., titles, times, genres, and the like). Set-top box 110 may include a game console. Set-top box 110 may include a user authentication device (e.g., a fingerprint scanner, retinal scanner, and the like). In some embodiments, a user of set-top box 110 may be identified using an authentication circuit and/or software, and in certain cases, authentication may be used to “customize” a set-top box to a particular user (e.g., by identifying the profile or preference setting of an authenticated user and providing media information according to the user's preferences). For example, a user may arrive at a hotel room, authenticate him/herself using a fingerprint scanner, and have his/her preference setting or profile imported by the set-top box, “configuring” the set-top box to provide the user's desired information.

Generally, the use of set-top box 110 includes display of media and metadata on display device 120. Information associated with the subject of an item of media may also be displayed, such as an actor in a movie, a car in an advertisement, or a name of a sports team. Operation of set-top box 110 may include the receipt of input from a user (e.g., via remote 130), and the display of further information (e.g., more or less detailed information, or different information). Information may be associated with one or more items of media content, and various embodiments allow a user to identify and play one or more items of media content.

Remote 130 is typically configured to allow a user to select information, parameters, values for parameters, items of content, and the like. Remote 130 may include various buttons, trackballs, accelerometers, motion and/or position sensors and circuitry, feedback/actuation components, and other circuitry as needed to provide for an interface between a user and various components of media system 100. In some embodiments, remote 130 may include one or more identification codes (e.g., a hardwareID and/or one or many userIDs). Remote 130 may sense gestures or motions from a user. Remote 130 may include a port to receive a physical storage device (e.g., a disc, memory card, and the like). Remote 130 may include a telephone. Remote 130 may include an authentication device (e.g., a circuit and/or sensor such as a fingerprint scanner, retinal scanner, and the like). In some embodiments, a user of remote 130 may be identified (or authenticated) using an authentication circuit and/or software, and in certain cases, authentication may be used to “customize” a set-top box to a particular user (e.g., by identifying the profile or preference setting of an authenticated user and providing media information according to the user's preferences). For example, a user may arrive at a hotel room, authenticate him/herself using a fingerprint scanner, and have his/her preference setting or profile imported by the remote, “configuring” the remote and/or set-top box to provide the user's desired information. Certain embodiments may include a radio-frequency identification (RFID) circuit (which may include associated software, antennae and the like). In some embodiments, identification (e.g., using RFID) may allow a user of remote 130 to “carry” his/her preferences and profiles from one set-top box 110 to another. For example, a user in one room of a house (with a first set-top box 110) may bring his remote 130 to another room of a house (with a second set-top box 110) and “transfer” his preferences to the second set-top box (e.g., begin watching a TV show in one room, then continue watching the TV show in the second room). Preference settings and/or profiles may be stored on remote 130, set-top box 110, display device 120, and/or a server in communication with any of these devices (e.g., server 140).

In some implementations, set-top box 110 includes a storage device, which stores at least a portion of one or more items of content for display on display device 120. In some configurations, items of content and/or associated information are stored on a server 140, which may include a database 142. Server 140 may be communicatively connected to set-top box 110 via a network 150. Network 150 may include the Internet. Network 150 may be a wide area network (WAN), a local area network (LAN), intranet, extranet, private network or other network, as well as a combination of these networks.

Network 150 may include one or more wireless networks, including various 802.11, 802.16, GSM and/or CDMA networks. In some configurations, set-top box 110 communicates with server 140 using a standard internet protocol (IP), and may use one or more IP addresses. In some cases, communications may include encrypted information.

Server 140 may include a database of media and associated metadata. In some embodiments, server 140 may be integrated with set-top box 110. In such cases, network 150 may also include various wired interfaces such as a communications bus.

The system of FIG. 1 may also include additional servers, for example application servers and network or web servers. The additional servers (not illustrated in FIG. 1) may allow set top box 110 to communicate with database 142 over network 150. For example, an application server communicatively connected between set top box 110 and database 142 may perform logic that eventually receives user input, processes the user input to determine an action to perform with respect to a user interface (e.g., add content indicia, provide meta-data for content, and so forth), retrieve content and/or content meta-data from database 142, and provide updated user interface data to set top box 110 over network 150.

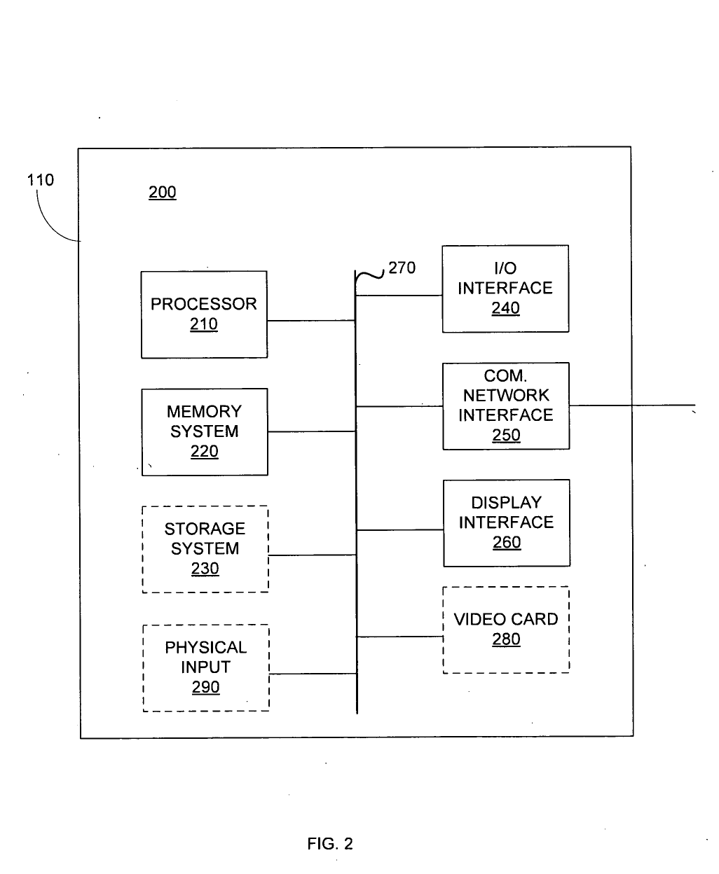

FIG. 2 is a schematic illustration of several exemplary components of a set-top box, according to certain embodiments. Set-top box 110 generally includes a housing 200, which may be sized to contain the various components of set-top box 110, and may be sized to sit atop display device 120. Certain set-top boxes may be sized to sit atop a “flat panel” display device, and may include one or more adjustable grips configured to removably attach the set-top box to the display device.

In exemplary embodiments, set-top box 110 includes processor 210, memory system 220, optional storage system 230, input/output (I/O) interface 240, communication network interface 250, and display interface 260. These components may be generally connected via a system bus 270. In some embodiments (e.g., depending upon hardware included within display device 120 (FIG. 1)), set-top box 110 may include video card 280. Set-top box 110 may also include a physical input device 290, which may include a sensor (e.g., a button) or other component that may be physically actuated (e.g., by a user).

Processor 210 may be configured to execute instructions. In some embodiments, processor 210 comprises integrated circuits or any processor capable of processing the executable instructions. In some embodiments, processor 210 may include a cache, a multi-core processor, a video processor, and/or other processors.

Memory system 220 may be any memory configured to store data. An example of memory system 220 includes a computer readable storage medium, which may include any medium configured to store executable instructions. For example, the memory system 220 may include, but is not limited to, storage devices such as RAM, ROM, flash memory, and/or other storage devices.

Certain configurations include storage system 230 as part of set-top box 110. In other configurations, storage system 230 may be implemented remotely, for example as part of server 140. Storage system 230 may be any storage configured to receive, store, and provide data. Storage system 230 may also include computer readable storage media such as flash memory, a hard drive, an optical drive, and/or magnetic tape. Storage system 230 may include a database or other data structure configured to hold and organize data. In some embodiments, set-top box 110 includes memory system 220 in the form of RAM and storage system 230 in the form of flash memory.

I/O interface 240 may include hardware and/or software to interface with various devices such as remote 130, a keyboard, touch screen, keypad, mouse, printer, scanner, or other I/O device. I/O interface 240 may receive information from a device and/or transmit information to the device.

Communication network interface 250 may communicate with various other devices, and such communications may include the use of network 150 (FIG. 1). Communication network interface 250 may support serial, parallel, USB, firewire, Ethernet, and/or ATA communications. Communication network interface 250 may also support 802.11, 802.16, GSM, CDMA, EDGE and various other wireless communications protocols.

Display interface 260 may include any circuitry used to control and/or communicate with a display device, such as display device 120. In some configurations, display interface 260 includes a video card and memory. In some configurations, display device 120 (FIG. 1) may include a video card, and display interface 260 may communicate with the video card of display device 120.

The functionality of various components may include the use of executable instructions, which may be stored in memory and/or computer readable storage media. In some embodiments, executable instructions may be stored in memory system 220 and/or storage system 230. Executable instructions may be retrieved and executed by processor 210, and may include software, firmware, and/or program code. Executable instructions may be executed by the processor to perform one or more methods.

Storage system 230 and/or memory system 220 may be configured to store one or more parameters, values, indicia, and/or items of content (e.g., media), such as a song, video, television program, movie, web page, video, blog, and the like.

In some embodiments, a user identifies one or more parameters and their associated values (or ranges thereof) by providing input with respect to an interface provided by set top box 110 through display device 120. Parameter identification may be performed using remote 130. A query reflecting the identified parameters and/or values may be created (e.g., by processor 210), and the query may be sent to server 140, for example as a SQL query. A query result may be returned by server 140 to set-top box 110 and displayed on display device 120.

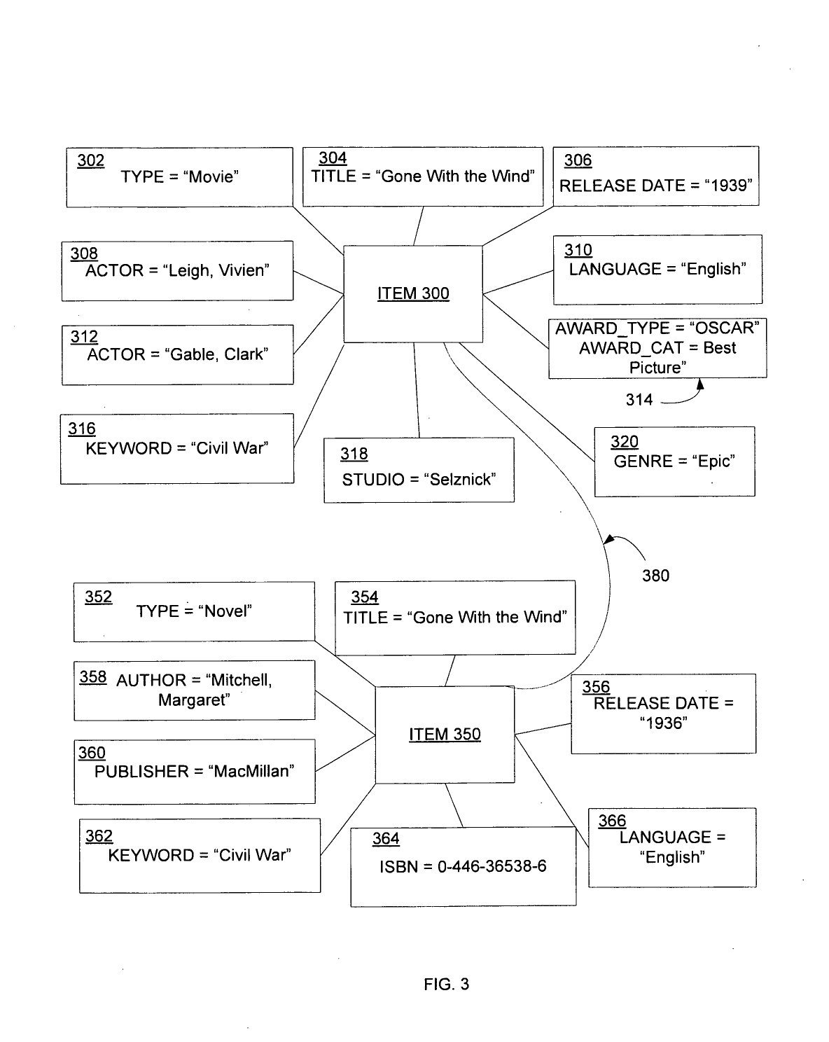

FIG. 3 illustrates a graphical representation of two exemplary items of content characterized by several exemplary parameters for illustrative purposes, according to some embodiments. FIG. 3 includes item of content 300 and item of content 350. FIG. 3 illustrates the characterization of item of content 300 by parameters 302, 304, 306, 308, 310, 312, 314, 316, 318, and 320, and of item of content 350 by parameters 352, 354, 356, 358, 360, 362, 364, and 366. Parameters may include (inter alia), type of content (movie, TV show, podcast, broadcast), the content's title, a date associated with the release of the content to the public, keywords, genre (westerns, mystery, comedy), duration, format (color, black and white, High Definition, aspect ratio, IMAX) sound quality (mono, stereo, surround sound, Dolby Digital, DTS), recommended by, awards (Golden Globe, Emmy, Academy Awards, Cannes, Sundance), availability (free, rental, purchase), MPAA/TV rating, ratings by critics, ratings by users, ratings by communities of users, time line, actor, director, writer, guest star, crew member, character name, plot line, language, subtitles, and the like. Some parameters may be associated with certain types of content, but not others. For example, a movie may be characterized by actors, whereas a book may be characterized by its publisher. Some parameters may be predicated on another parameter. For example, the parameter AWARD_CATEGORY=“Best Picture” may distinguish among several items sharing AWARD_TYPE=“Oscar” as shown in parameter 314.

Some parameters may be user-specific, IP-address-specific, or “set-top box specific.” For example, user parameters may include “content I have not watched yet,” “my favorites,” “recommended by my friends,” or “recommended according to my preferences.” In some cases, a profile may be modified by recording one or more preferred parameters and/or values (e.g., values associated with an item of content that is watched in its entirety). In some embodiments, a profile may be used to identify other media that share values for one or more parameters associated with the profile, and in some cases, identified media are proposed to the entity associated with the profile.

A user may identify an item of content by a single parameter and/or a single value for a parameter. A user may identify media by choosing values for a plurality of parameters. In some cases, a user chooses a range of values for a parameter, and media (or their indicia) characterized by the parameter and having values within the range are displayed.

Items of content may share parameters and/or values for parameters, and so may be described as “overlapping.” In some embodiments, an “overlap metric” may describe the degree with which two or more items of content are related to each other. For example, an overlap metric associated with two media may be a summation of the number of parameters that have the same value for the two media. In some cases, the summation may be normalized by an importance of the parameters. Overlapping items may also be linked explicitly (automatically and/or with user input), as illustrated by link 380. Rules-based logic may be applied to parameters and/or values. A value for one parameter may cause the unavailability of values for other parameters (e.g., a logical result of a first value may affect other parameters). For example, a STUDIO parameter taking the value “Disney” may automatically exclude media having an MPAA rating of “X.” In some embodiments, logical operands or connectives (either automatically imposed or manually input) may improve the efficiency of information retrieval from a database. Certain embodiments include logical operators (e.g., among parameters and/or values) such as AND, OR, NOT, GREATER THAN, LESS THAN, BETWEEN, MEMBER OF (A SET), INCLUDES, and other functions.

In FIG. 3, items of content 300 and 350 each include a TITLE parameter having the value “Gone with the Wind.” A user searching for media by choosing items having the title “Gone with the Wind” might find both items of content 300 and 350.

A user may also find media by narrowing down a range of values for parameters of interest. For example, a user interested in the Civil War may be interested in hundreds of items of content that include KEYWORD values of “Civil War,” including items of content 300 and 350. Choosing parameters and values to narrow a search (e.g., GENRE=“Epic” and AWARD_TYPE=“Oscar”) may result in a subset of items for viewing (e.g., item 300).

In some embodiments, a combination of values for various parameters may uniquely identify an item of content. For example, the set of values (for parameters) {TITLE=“Gone With the Wind” AND TYPE=“Movie” AND LANGUAGE=“English” might uniquely identify item of content 300.

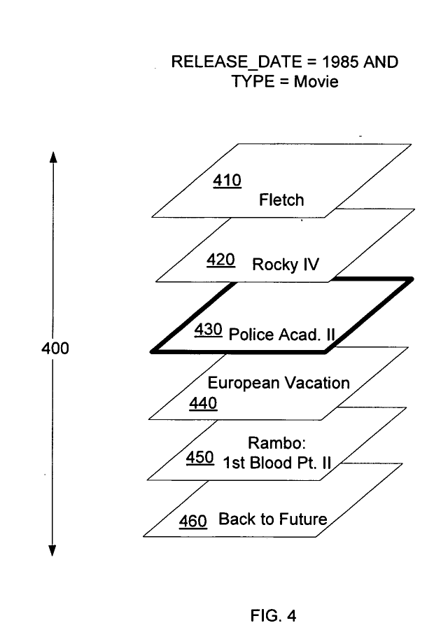

FIG. 4 illustrates a graphical arrangement of indicia associated with several items of content, according to certain embodiments. In this example, items of content 410, 420, 430, 440, 450, and 460 are characterized by a TYPE parameter having a range of values “Movie” and a RELEASE DATE parameter having a range of values “1985.” A range of parameters may include one or many parameters. A display as in FIG. 4 may result, for example, by creating a query having the constraints shown, and sending the query to database 142 (FIG. 1). Results of the query may be returned and displayed, for example, as shown in FIG. 4.

FIG. 4 illustrates a graphical display representing several items of content (e.g., movies released in 1985). Each item of content (or a corresponding reference or indicia) may include information that identifies the item (e.g., a Title). In some cases, indicia include information associated with the item per se. In some cases, indicia include information associated with a query that resulted in the display of the item. For example, a query may request media from 1950-1990, and indicia may be graphical representations of the decades “1950's,” “1960's,” “1970's,” “1980's,” and “1990's.” A refinement of the query request may limit the displayed indicia to reflect only TV shows, which may cause a change in the displayed information (e.g., the indicia become the shape of TV-sets to reflect that they represent TV shows).

Items of content may be arranged in a direction 400. Direction 400 may be a straight, curved, circular, angled, or otherwise shaped “line” that identifies items sharing values for one or more parameters associated with direction 400. Direction 400 may be a column or a row and associated with a perceived “depth” of the display. In some embodiments, items associated with a direction 400 share one or more values and/or one or more parameters. In the example shown in FIG. 4, items of content 410-460 share values for RELEASE_DATE (1985) and TYPE (Movie), and so direction 400 represents items that share these values. Certain displays include several directions (e.g., several columns of indicia). In some cases, each direction is associated with a parameter. In some embodiments, a parameter describes a relationship between direction (e.g., a parameter describes an arrangement of columns). For example, a first column may be “1950's,” an adjacent column may be “1960's,” and an additional column may be “1970's.”

Items of content (and/or their indicia) may be arranged in an order (e.g., in a direction such as direction 400). Items may be ordered according to their values for the parameter associated with the respective direction of the ordering. For example, indicia arranged in a direction 400 associated with a parameter may be ordered by their respective value for that parameter.

In some embodiments, the items are arranged in an order associated with a value for a parameter other than the parameter associated with the direction. For example, items may be ordered alphabetically or in an order associated with an episode number. Items may be arranged in an order associated with a preference and/or profile (e.g., with “most desirable” or “most likely of interest” items prominently featured); in some embodiments, this preference is recalculated repeatedly, and in some cases after each query. In some cases, an arrangement or order is associated with an availability (e.g., “free” items having prominence over “rental” items or items available for purchase). In some embodiments, an arrangement or order may include input from a third party, such as an advertiser, a friend, or a group of people. An order may be applied to a playlist, and may represent a sequence in which a plurality of items may be watched.

Information may be arranged as discrete items. Information may also include substantially “continuous” information (e.g., a single item of information). Some information may benefit from discrete display, some may benefit from continuous display. For the purposes of this specification, information is displayed as discrete components for illustrative purposes only.

Items may be arranged in an order associated with values for a plurality of other parameters. For example, FIG. 4 may be ordered in a fashion that groups items sharing values for one or more parameters other than RELEASE_DATE and TYPE. For example, item of content 420 (Rocky IV) and item of content 450 (Rambo, First Blood Part II) both star the actor Sylvester Stallone; these items may be grouped together in some embodiments. In other orders, items may be grouped by GENRE—comedies grouped with other comedies, dramas grouped with other dramas and the like. In some cases, items may be arranged or ordered based on an overlap metric associated with desirable media.

FIG. 4 illustrates a distinction (in this case, a bold line border) between a “highlighted” item of content and other items of content. In FIG. 4, item of content 430 is “highlighted.” Highlighting may be used to identify an item of content (and/or indicia) upon which further action may be taken. For example, a user may highlight an item to retrieve further information about the item and/or play the media associated with the item.

In some embodiments, a display may “pivot” (e.g., as with a pivot table) about a highlighted item, creating a display of one or more new directions associated with displayed media. In some cases, a user may highlight an item of content and pivot to generate a new display that is “pivoted” around the highlighted item. Pivoting may create a display that includes one or more new parameters and/or values. A display may include any number of directions. In some cases, adding a displayed direction may cause the removal of another displayed direction (e.g., the removal of associated media and/or indicia). In some cases, a display may be modified to add a new direction to already displayed directions.

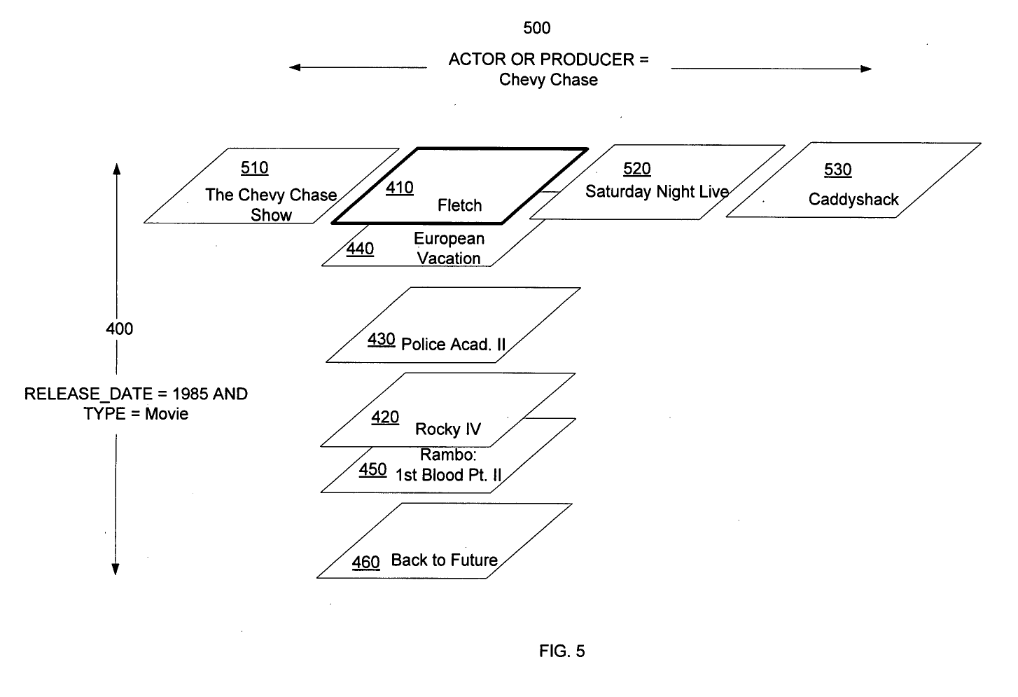

FIG. 5 illustrates a display showing two directions, according to some embodiments. A first direction 400 may be associated with items of content 410, 420, 430, 440, 450, and 460 that share values for RELEASE_DATE (1985) and TYPE (Movie). In this example, items of content in direction 400 are grouped within direction 400 (e.g., ordered) according to a starring actor.

FIG. 5 also illustrates a second direction 500. In this example, direction 500 includes items of content 510, 520, and 530 for which the parameters ACTOR or PRODUCER=“Chevy Chase.” In this example, direction 500 includes television shows (items of content 510 and 520) and movies (items of content 410, 440, and 530), and may include items having a range of RELEASE_DATE values (not shown).

In some embodiments, a descriptor (e.g., a text block) associated with a direction is displayed. For example, the column (items of content 410-460) may include a heading (e.g., “Chevy Chase”), or the row (items of content 510, 410, 520, 530) may include a heading (e.g., “1985 Movies”). A heading may reflect a query associated with the direction (e.g., values of parameters). A heading (and by extension, a direction) may also reflect other parameters. For example, a display may include columns of information (and optionally headings) reflecting “My Favorites” “Recommended by my Social Network” “New to Me” “History” “Recommended by ZillionTV” and the like. A direction (and optionally heading) may include “Highest Overlap,” which may reflect (for example) items of content similar to items of content recently viewed (e.g., as determined by an overlap metric between recently viewed and unwatched items).

In some embodiments, a user selects a parameter and range of values. Indicia of media characterized by the selected parameters and having values within the range may be arranged in a first direction. In some embodiments, media sharing values with those arranged in the first direction are displayed in one or more second directions.

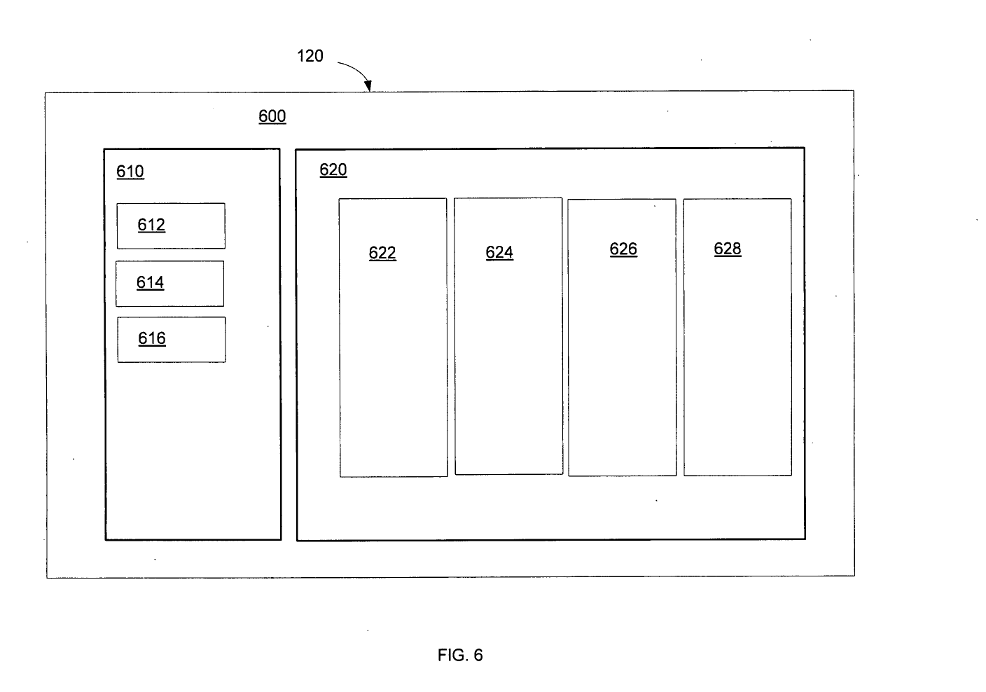

FIG. 6 illustrates a display according to certain embodiments. Display 600 includes a query region 610 and a results region 620. In FIG. 6, query region 610 and results region 620 are “discrete” regions; in other embodiments these regions may overlap and/or be superimposed.

Query region 610 may include filters 612, 614, and 616. More or fewer filters may also be included. Filters (e.g., filters 612, 614, and 616) may represent a parameter and/or a range of values for the parameter. Each of filters 612, 614, and 616 may also describe a plurality of parameters and associated ranges. Certain embodiments create a filter from a preference and/or a profile.

Results region 620 includes information 622, 624, 626, and 628, shown in this example as discrete areas of information. More or fewer regions of information may be displayed, as may overlapping information. Information (e.g., information 622-628) may include indicia of parameters, values, and/or media. In some embodiments, information 622, 624, 626, 628, includes indicia arranged in a direction (e.g., a row or column) and may be ordered according to values for a parameter associated with the direction (or with other parameters).

Query region 610 may be used to represent a query. A query may be represented by filters on parameters. A filter may select one or more parameters, and may also select a range of values for a parameter. Filters 612, 614, and 616 may be combined (e.g., with AND, OR, NOT and/or other operators) to form a query request. One or more filters may be used to create a query request, which may be a request for media (or associated information) having values for parameters within a desired range, typically as reflected in query region 610.

A query request may be sent directly or indirectly to a database having media and associated information, such as database 142. The database may provide a query result, which may include media (and/or their indicia) that satisfy the query result (e.g., satisfy the filters or other criteria represented in query region 610).

The query result may be displayed in results region 620. In some embodiments, results region 620 may indicate information (e.g., a parameter and/or values) that may be used to form a new query in query region 610. For example, a user may identify (e.g., highlight or tag) one or more indicia in results region 620, and a query that would result in the same identification may be created in query region 610.

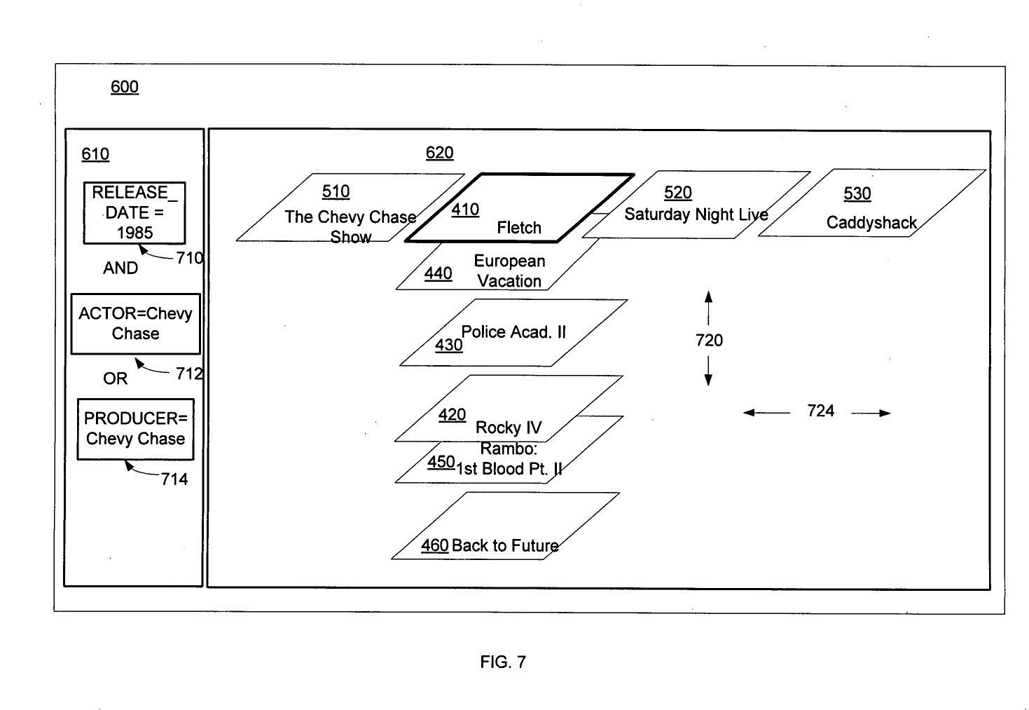

FIG. 7 illustrates a display of a query request and an exemplary query result according to certain embodiments. Query region 610 illustrates filters 710, 712, and 714, which (in this example), may be used to create a query request for media released in 1985 for which Chevy Chase was either an actor or producer. Results region 620 may display indicia of media satisfying the query result. In this example, indicia are arranged in two directions. Direction 720 is associated with filter 710 (RELEASE_DATE=1985) and direction 724 is associated with the combination (via the OR operator) of filters 712 and 714.

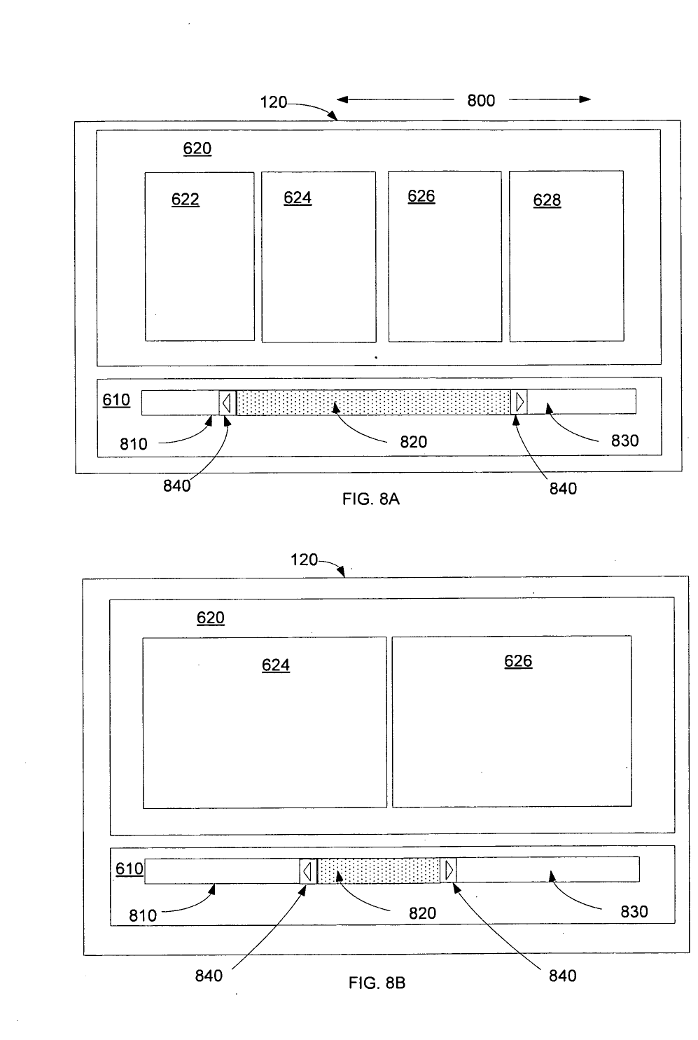

FIGS. 8A and 8B illustrate a control bar, which may be used as a filter in some embodiments. In FIG. 8A, results region 620 includes information 622, 624, 626, and 628 arranged in direction 800. Query region 610 includes control bar 810, also oriented lengthwise in direction 800. Control bar 810 may be associated with a parameter, and may include a graphical representation of the parameter. Control bar 810 may also include a textual representation of the parameter.

A parameter controlled by a control bar may have a range of values. A control bar may be used to select a subset of the range, and may indicate which values are within and outside the selected range. In FIG. 8A, control bar 810 indicates an inside range 820 and an outside range 830. In some embodiments, inside range 820 indicates those values associated with information displayed in results region 620 (e.g., information 622, 624, 626, 628). Outside range 830 may correspond to values outside those values associated with indicia displayed in results region 620.

Inside range 820 and outside range 830 may be separated by sliders 840. Sliders 840 may be operated (e.g., moved) to change the range of values associated with results region 620. In some embodiments, a pair of sliders may create a dynamic interface that displays values for a parameter between the values of a first and second slider. In some embodiments, moving one or more sliders 840 generates a new query, whose corresponding result is manifest in results region 620.

In some cases, the information displayed in results region 620 may dynamically respond to changes in a query request (e.g., movement of a slider). In FIG. 8B, sliders 840 have been moved (with respect to those in FIG. 8A) such that a smaller range of values for the controlled parameter is selected. In this example, a smaller region 820 (FIG. 8B) indicates a smaller subset of values associated with results region 620 as compared to FIG. 8A. A correspondingly smaller set of information (e.g., information 624 and 626) are displayed in results region 620 in FIG. 8B as compared to FIG. 8A. In some cases, an information content associated with each item of information may be increased (e.g., adding more detail to various indicia of media and/or other information).

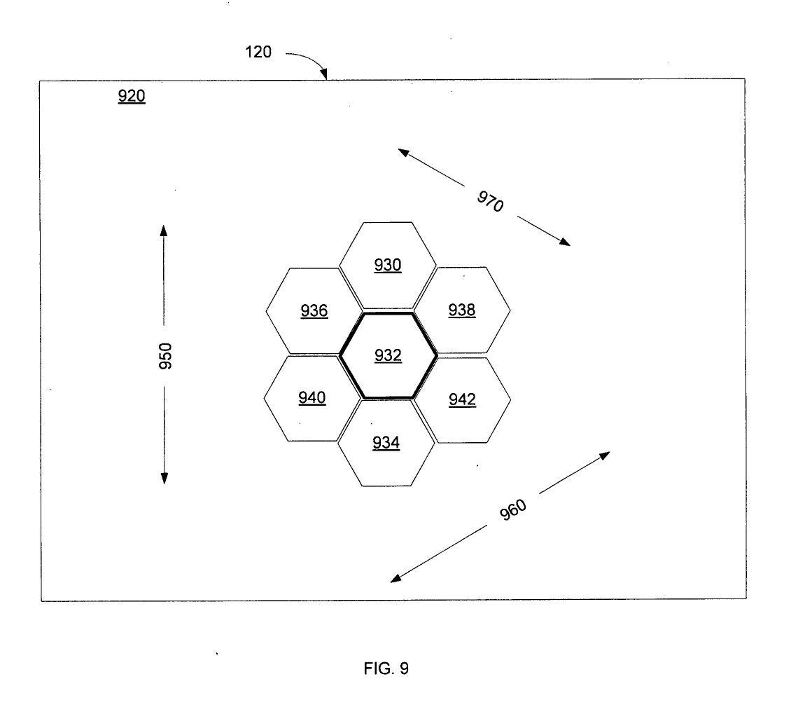

FIG. 9 illustrates a results region according to some embodiments. In FIG. 9, results region 920 includes indicia 930, 932, 934, 936, 938, 940, and 942. Indicia may represent media, media information, sets of information, parameters, values and the like. In this example, indicia are arranged in several directions, including directions 950, 960, and 970. In some cases, each direction may be associated with one or more parameters, and an arrangement in that direction may be associated with indicia sharing a value or values for that parameter. For example, indicia 930, 932, and 934 may be characterized by a RELEASE_DATE=“1985,” and oriented in direction 950, indicia 936, 932, and 942 may all be characterized by a GENRE=“Comedy” and oriented in direction 970, and indicia 938, 932, and 940 may all be characterized by an ACTOR=“Chevy Chase” and oriented in direction 960. Highlighted indicia 932 may correspond to one or more comedies released in 1985 in which Chevy Chase was an actor.

In some cases, one or more control bars may be associated with each direction 950, 960, and 970.

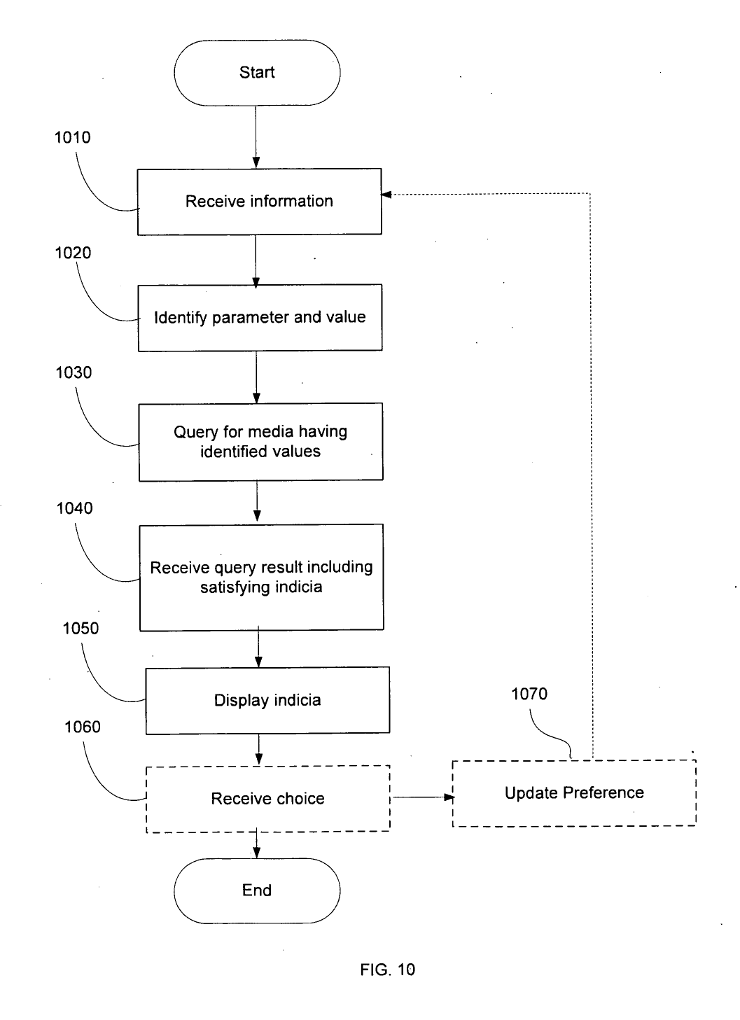

FIG. 10 illustrates a flow chart of an exemplary method for providing media information through an interface, according to certain embodiments. In step 1010, information associated with media that may be of interest is received. In some cases, such information may be received from a user in the form of input through a remote control device or in some other manner. In some cases, such information may include a preference or profile associated with a user.

In step 1020, one or more parameters and values are identified within the received information. In some cases, the information may include key-value pairs. In some cases, a search engine may be used to search the provided information and match the search results to parameters and/or values in a database of media information.

In step 1030, a query request may be generated, which may request media and/or media information characterized by values that match the identified parameters from the received information. The query result may be generated by set top box 110 and transmitted to database 142. The query transmission may be received and relayed between set top box 110 and database 142 by one or more network servers and one or more application servers.

In step 1040, a query result satisfying the query request may be received by set top box 110. Typically, the query result may include media and/or indicia that satisfy the query request.

In step 1050, the received media and/or indicia (satisfying the query) may be displayed. Thus, the media and/or indicia is retrieved from the query by set top box 110, the data is populated or otherwise incorporated into a graphic interface, and the interface is provided through display device 120 by set top box 110. In optional step 1060, a choice of one or more displayed items may be received. The choice may be received as user input received by set top box 120 that corresponds to an element in the graphic interface. In some cases, a choice may result in an updating of a preference, a profile, or other information, as shown in optional step 1070. In some cases, the receipt of a choice may result in a new query for media reflecting the choice.

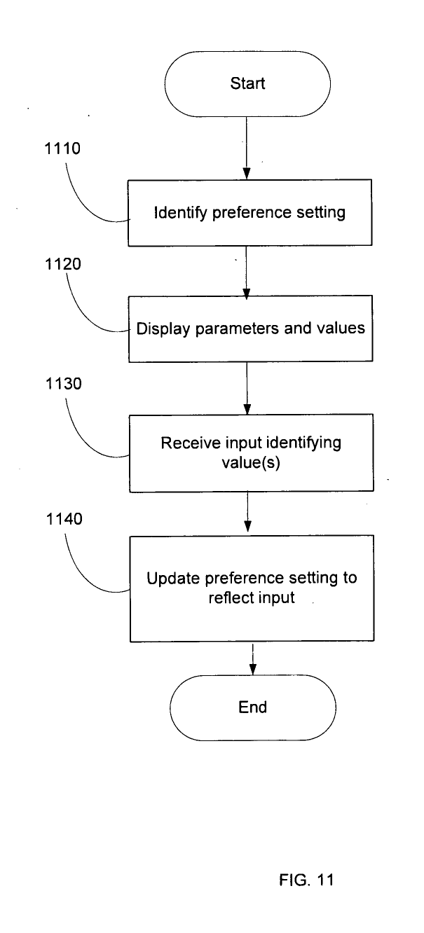

FIG. 11 illustrates a flow chart of an exemplary method for updating a preference setting, according to certain embodiments. In step 1110, a preference setting is identified. A preference setting may be associated with a user, a set-top box, a communications session, a time, a parameter and/or values for parameters. In some embodiments, a preference setting includes a preferred range of values for one or more parameters (e.g., 1990's Mystery Movies in the French language). A preference setting may be associated with a user's interests. A preference setting may be associated with media viewed by a user. A preference setting may be associated with an advertising protocol. For example, some users may wish to view media without advertising. Some users may with to view advertising before and/or after media. Some users may wish to view advertising during media. In some cases, users may be rewarded for viewing advertising, and a reward protocol may be associated with a user's preference setting.

In some embodiments, a user's interests may be calculated from viewing behavior. For example, whether or not an item is viewed, the amount of time spent viewing an item, the number of times an item is viewed, may be used to discern a user's interest in the item, and by extension, in values for parameters characterizing the item.

In step 1120, a graphical representation of the preferred parameters and values may be displayed. In some cases, indicia of media having preferred values may be displayed. In certain cases, a preference setting may include whether or not an item of media has been viewed before, and in some embodiments, items not yet viewed are displayed more prominently (i.e., “featured”) than those that have been viewed. Media having higher values for an overlap metric (calculated against the preference setting) may also be featured.

In step 1130, input identifying one or more parameters and/or ranges of values (or a single value) for one or more parameters may be received. In some cases, input identifying an item of content (e.g., selecting a TV show for viewing) may be received.

In step 1140, the preference setting may be updated to reflect the received input. For example, if a user identifies a particular range of values for a parameter (e.g., movies in the Tamil language), the preference setting may be updated to reflect a preference for Tamil and a preference for movies. In some cases, such a preference setting may affect which media are proposed to a user (e.g., the user who enjoys Tamil movies may be offered songs and TV shows in Tamil). In some cases, the preference setting may be used to customize advertisements displayed to a user. For example, a user in the United States (characterized by a geographic parameter) who enjoys movies in Tamil may be offered travel services to India.

In some embodiments, a preference may be “inferred.” For example, an item of content that is watched in its entirety may be inferred to be of greater interest than an item of content for which the first few minutes are watched, but the remainder remains unwatched. In some embodiments, one or more topics are associated with “scenes” or other aspects of content, and a user's behavior with respect to each scene may be used to infer an interest in the topic. For example, a user that repeats a car-chase scene in a movie may have a profile that includes an interest in cars and/or an interest in the locale in which the scene occurs, and/or an interest in stunt driving.

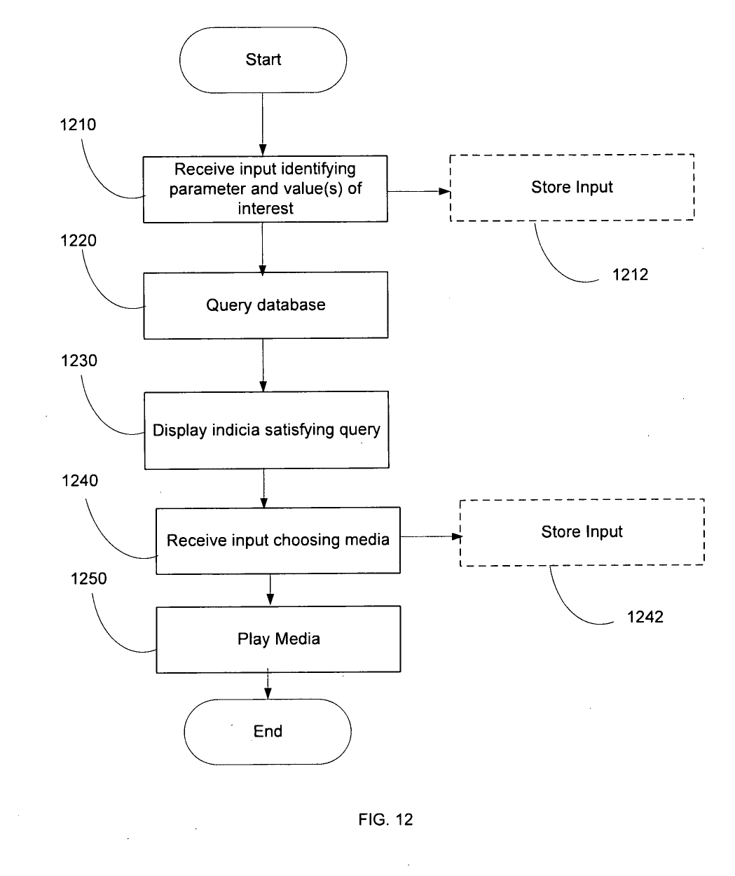

FIG. 12 illustrates a flow chart of an exemplary method for providing media, according to certain embodiments. In step 1210, input is received (e.g., from a user) that identifies one or more parameters. Typically, each parameter may characterize one or more media or other content. The identified parameter may include a range of values, typically corresponding to desirable characteristic of the media. In some embodiments, input may be stored. Stored input may be used (for example) to update a preference setting and/or update a profile.

In step 1220, a query for media characterized by the input parameter(s) and value(s) may be generated and submitted. A query may request media having values for the identified parameters that fall within the identified range. Set top box 110 may generate the query and transmit the query to database 142, for example through one or more web servers and application servers (not illustrated in FIG. 1). Database 142 receives the query, retrieves media that satisfies the query, generates a query result and transmits the result to set top box 110, through any intermediary servers if necessary. Typically, the query request includes media and/or associated information that satisfies the constraints of the query.

In step 1230, indicia of media satisfying the query may be displayed through display device 120 by set top box 110. Indicia may be arranged in one or more directions, and may be ordered in one or more orders. In some cases, indicia may be associated with a plurality of media (e.g., an icon representing a season's worth of episodes of a TV program). In some cases, each indicia may be associated with a single item of media content (e.g., a Movie title).

In step 1240, input (e.g., from a user) choosing one or more of the displayed indicia may be received by set top box 110. The input may be associated with a graphical interface which contains the indicia and is provided by set top box 110 through display device 120. In some embodiments, this input may be stored (e.g., as in optional step 1242) to database 142.

In step 1250, one or more media corresponding to the chosen indicia may be played. The media may be played through display device 120 by set top box 110.

In some embodiments, a profile associated with a user may be modified by a user. In some cases, a user may create a preference setting (e.g., by identifying preferred media). In some embodiments, a profile of a user may be created (e.g., a demographic profile). A profile may be modified by a user's choice of parameters, values, and/or media. A preference and/or profile may be used to create a filter, which may be used to customize a query request for a particular user.

Certain embodiments combine aspects of push and pull interfaces. A choice of media may be presented to a user. The user's identification of parameters and values of interest (e.g., in choosing media) may then be used to modify a profile associated with the user. Media that match the modified profile may be calculated (e.g., using an overlap metric), and proposed to the user. The user's response to the proposed media may be further used to modify the profile. As such, a behavior associated with a user's choice of media may be used to propose additional media, better-matched to the user's interest.

Displayed information and/or indicia may include visual and/or audible information. Information may include static information (e.g., a photograph or text) or dynamic information (e.g., a video or a stock “ticker tape” display). Information may typically be associated with values for one or more parameters associated with various items of content. Information may be specific to a single item of content, or describe several items of content. Information may include the display of an item of content per se (e.g., playing a video).

Various embodiments may enhance a user's ability to find desired media for viewing or listening. A trajectory through an N-dimensional parameter space may be efficiently navigated by graphically displaying information associated with parameters, allowing users to select a desired range of values for those parameters, and allowing a user to “zoom in” to one or more desired items of content (e.g., select a subset of the range, sometimes repeatedly). Thus, a display of media information may be dynamic and interactive, and provide a user with a wide variety of ways to choose media. A user may choose which parameter to control (e.g., via a control bar or other query input) from among many or even all of the parameters available to characterize items of content. A user may select desired ranges of values for parameters, and may dynamically change the parameters being controlled and/or the range of values being displayed. As such, a user may find media using a variety of identification processes.

In some embodiments, a playlist may be created. A playlist may include a plurality of media. A playlist may result from a query, which may include constraints on one or more parameters and/or one or more values for parameters. In select embodiments, a plurality of filters is combined (e.g., logically) to generate a query request, and a playlist includes media satisfying the query request. A playlist may provide a user with a customized series of media having desirable characteristics.

Playlists may be updated (e.g., re-queried). For example, a playlist may reflect a newly released episode of a TV series. The playlist may reflect “only the newest episode” or “all the unwatched episodes” or “all of this season's episodes” or any other user preference. A playlist may provide a series of media to a user without requiring the user's action (e.g., somewhat like a “push” interface). A playlist may be customized to a user's interests (automatically and/or with user input), and be tailored to provide only items of content of interest to the user (e.g., somewhat like a “pull” interface). In some embodiments, a viewer-user interface combines features of push and pull interfaces.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A digital media device comprising:
first hardware configured to instruct a display device to display information comprising:
a representation of one or more parameters characterizing one or more media,
a range of values for at least one of the represented parameters, and
indicia of one or more media having values for at least one of the represented parameters within the range; and
second hardware connected to the first hardware and configured to:
send a query request to a database of media and associated parameters,
receive a query result respondent to the query request, and
communicate the query result to the first hardware.

2. The device of claim 1, wherein any of the first and second hardware is configured to receive an input identifying any of a parameter, a value of a parameter, a range of values of a parameter, one or more indicia, and one or more items of media content.

3. The device of claim 2, wherein the input is received from a remote control.

4. The device of claim 2, wherein any of the first and second hardware is further configured to generate a query request reflecting the received input.

5. The device of claim 4, wherein the received input identifies a first parameter and a range of one or more values of the first parameter, the query request reflects the first parameter and the range, and the query result includes one or more media having values for the first parameter within the range.

6. The devicet of claim 5, wherein the communication of the query result to the first hardware causes the displayed information to reflect the query result.

7. The device of claim 1, wherein the query request includes a SQL query.

8. The device of claim 1, wherein the database includes a relational database.

9. The device of claim 1, wherein two or more indicia are graphically arranged in a first direction associated with a first parameter characterizing the media represented by the two or more indicia.

10. The device of claim 9, wherein the two or more indicia are graphically arranged in an order associated with respective values of the first parameter.

11. The device of claim 9, wherein the two or more indicia are graphically arranged in an order associated with respective values of a second parameter characterizing the media represented by the two or more indicia.

12. The device of claim 1, further comprising a display device in communication with the first hardware.

13. The device of claim 12, wherein the display device is physically integrated with the component.

14. The device of claim 1, wherein one or more of the represented parameters signifies any of a price of the media, a rental fee associated with the media, a type of media, a genre describing the media, an availability of the media, a recommendation from a first user, a recommendation from two or more second users, a rating associated with the media, a preference associated with a first user, an actor acting in the media, an author of the media, a studio affiliated with the media, a time associated with the media, a release date of the media, a director of the media, a producer of the media, and a Box Office metric associated with the media.

15. The device of claim 1, wherein one or more of the represented parameters is associated with a product or service displayed during a playing of the media.

16. The device of claim 1, wherein one or more of the represented parameters is associated with a rewards program.

17. A method of displaying one or more items of content by a computing device, the method comprising:
receiving first information with a computing device, the first information associated with an interest of a first user;
identifying one or more parameters within the first information, each parameter including a value associated with the interest;
querying a database for one or more items of content having the value of the identified parameter;
receiving a query result with the computing device, the query result including indicia of items of content satisfying the query, and
displaying one or more of the received indicia to a second user.

18. The method of claim 17, wherein the second user is the first user.

19. The method of claim 17, wherein the first information is provided by the first user.

20. The method of claim 17, wherein the first information includes any of a price of an item, a rental fee associated with the item, a type of item, a genre describing the item, an availability of the item, a rating, an actor acting in the item, an author of the item, a studio affiliated with the item, a time associated with playing the item, a release date of the item, a director of the item, a producer of the item, and a Box Office metric associated with the, and an MPAA rating of the item.

21. The method of claim 17, wherein the first information includes a preference including information provided by any of the first and second users.

22. The method of claim 17, wherein the first information includes a profile associated with any of the first and second users.

23. The method of claim 22, wherein the profile includes a demographic associated with the profiled user.

24. The method of claim 22, wherein the profile includes one or more parameters having a value associated with an item of content previously viewed by any of the first and second users.

25. The method of claim 17, wherein the first information includes a recommendation from the first user.

26. The method of claim 17, wherein the first information includes a recommendation from a plurality of third users.

27. The method of claim 17, wherein any of receiving and proposing includes using an internet protocol.

28. A method of customizing a media interface, the method comprising:
identifying a preference setting;
displaying information including:
a representation of one or more parameters, and
a range of values for at least one of the represented parameters;
receiving input that identifies one or more values within the range; and
updating the preference setting to reflect the received input.

29. The method of claim 28, wherein the one or more parameters and their associated values characterize one or more items of digital media.

30. The method of claim 28, further comprising updating the displayed information to reflect the updated preference setting.

31. The method of claim 28, further comprising receiving an instruction to play an item of digital content characterized by a parameter having a value within the displayed range.

32. The method of claim 28, wherein the preference setting is associated with a first user.

33. The method of claim 32, wherein the input is received from the first user.

34. The method of claim 28, wherein the input includes a preference setting associated with a first user, and the input is received from a second user.

35. The device of claim 1, wherein any of the query request and query result includes an internet protocol address.

36. The device of claim 35, wherein the internet protocol address is associated with any of the first and second hardware.

37. A method for providing media, the method comprising:
receiving a first input identifying a parameter and one or more values for the parameter;
querying a database for media having a value that matches one or more of the identified values;
displaying indicia of media having the matching value;
receiving a second input choosing one or more of the displayed indicia; and
playing the media associated with the chosen indicia.

38. A media information system comprising:
a processor;
a computer readable storage medium connected to the processor and having embodied thereon a program executable by the processor to perform a method comprising:
instructing a display device to display information comprising:
a representation of one or more parameters, each parameter characterizing one or more media,
a range of values for at least one of the represented parameters, and
first indicia of one or more media having a value for at least one of the represented parameters within the range;
receiving an input identifying any of a parameter, a value of a parameter, a range of values of a parameter, one or more indicia, and one or more media;
generating a query request reflecting the input;
sending the query request to a database of media and associated parameters;
receiving a query result from the database; and
displaying second indicia associated with media satisfying the query result.

39. The device of claim 2, wherein the remote control includes an authentication circuit.

40. The device of claim 39, wherein the authentication circuit includes a fingerprint reader.

41. The device of claim 2, wherein the remote control includes an RFID circuit.

42. The device of claim 1, further comprising an authentication circuit connected to any of the first and second hardware.

43. The device of claim 42, wherein the authentication circuit includes a fingerprint reader.

44. The system of claim 38, further comprising an authentication circuit connected to the processor.

45. The system of claim 44, wherein the authentication circuit includes a fingerprint reader.
